(19) United States
(12) Patent Application Publication
(10) Pub. No.: US 2023/0217978 A1
(43) Pub. Date: Jul. 13, 2023

(54) PALATABLE BLENDED COMPOSITION HAVING CANNABIS OIL

(71) Applicant: Bright Green Corporation, Wilmington, DE (US)

(72) Inventor: V. Hari, Orlando, FL (US)

(21) Appl. No.: 17/570,447

(22) Filed: Jan. 7, 2022

(51) Int. Cl. A23L 33/105; A23L 27/00; A23L 27/10; A23L 33/15; A23L 33/16

(52) U.S. Cl. CPC A23L 33/105; A23L 27/80; A23L 27/88; A23L 27/115; A23L 33/15; A23L 33/16

(57) ABSTRACT

An example method of producing a blended oral composition includes combining cannabis oil, turmeric curcuminoids, flavonoids, and pepper.

### BACKGROUND

The present disclosure relates to a palatable blended oral composition including Cannabis oil.

Cannabis sativa including C. indica, C. ruderalis and their various sub species, varieties, hybrids, and eco-bio types contain different quantities of about 90 Phyto-Cannabinoids. Among these are tetrahydrocannabinol (THC) and cannabidiol (CBD), as well as other Cannabinoids, have been used to treat medical conditions or for their calming effects.

### SUMMARY

An example method of producing a blended oral composition includes combining cannabis oil, turmeric curcuminoids, flavonoids, and pepper.

### DETAILED DESCRIPTION

Palatable blended oral compositions having cannabis oil can be used to treat multiple medical conditions and for relaxation. In this disclosure, example blended oral compositions include cannabis oil, turmeric curcuminoids, flavonoids, and pepper. The example compositions can also include a mix of Cannabinoids and/or terpenes. The composition can include different ratios of tetrahydrocannabinol (THC) to cannabidiol (CBD) in a non-addictive and non-psychotic concentration along with black or white pepper extracts or colloids in a vitamin- mineral enriched flavored medium with and without sweeteners.

The Cannabis oil may be total cannabis oil containing various cannabinoids such as tetrahydrocannabinol (THC) and cannabidiol (CBD) alone or together with other cannabinoids like Cannabinol (CBN), Cannabigerol (CBG), Cannabichromenic acid (CBCa), tetrahydrocannabivarin (THCV) and cannabis terpenes, or CBD oil (Cannabidiol) with no trace of THC but containing various terpenes or oil containing various ratios of CBD to THC with or without other non-psychoactive cannabinoids and terpenes.

The example blended oral composition can include Turmeric Curcuminoids. The Turmeric Curcuminoids can act as an anti-inflammatory agent, immune-modulator and adaptogen in traditional and alternative medicine for treatment of a multiple range of medical conditions.

The blended oral composition can also include plant flavanoids that can provide various health benefits. The flavonoids are compounds synthesized by plants, and they have medical related properties, such as antioxidant, anticancer, anti-inflammatory, and antibacterial, among others.

Similarly, extraction of flavanoids from plants is an involved procedure and there are many options for extraction that are in the common domain not covered by patents.

Black and white pepper from Piper nigrum potentiate the bioavailability of many supplements as an enhancer and is also used in alternative medicine as an appetite stimulant as well as other conditions. An essential oil of Piper nigrum can be extracted by steam distillation or super critical CO2 extraction protocols. The pepper can also be finely powdered and suspended in an oil-water emulsion to form a colloidal suspension. Guar gum from Cyamopsis tetragonoloba is an emulsifier as well as thickening and binding agent with certain medicinal applications.

Both Cannabis oil as well as curcumin in turmeric is hydrophobic and can be extracted by critical CO2 extraction of Cannabis and rhizomes of Curcuma longa, respectively.

The blended oral composition can include emulsified and compounded Cannabis oil, turmeric extract, as well as plant flavanoids for use in favored or unflavored beverages. The blended oral composition can also include a colloidal suspension or extract of white and/or black pepper containing a vitamin and mineral enriched flavored oral preparation. The vitamin and mineral content meet RDA requirements as set forth by the U.S. pharmaceutical convention. This blend can be consumed orally both as a nutritional drink with a calming effect as well as a potentially medicinal therapeutic oral agent.

The blended oral composition is gluten free and avoids toxic levels of heavy metals by growing the plants from which the oil is extracted under highly controlled conditions in a semi-automated green house where each plant will be tracked. The blended oral composition may be made on a large scale after keeping the sequence of addition of ingredients with all operations are conducted in a germ-free environment.

The blended oral composition may also be used in protein drinks for diabetics and non-diabetics with no sweeteners. Alternatively, the blended oral composition is sweetened with zero calorie synthetic or natural sweeteners or with refined or unrefined sugars, such as those derived from cane, beet, maple, honey or other sources such as honey. The blended oral composition can also contain one or other different flavoring agents and sterilized as a concentrated tonic or as a palatable carbonated or non-carbonated soft drink of variable volumes. Furthermore, the blended oral composition can be incorporated into concentrated liquid capsules, gummies, liquid centered candies, or other oral forms. The blended oral composition can also be used for veterinarian purposes.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of producing a blended oral composition, consisting essentially of combining cannabis oil, turmeric curcuminoids, flavonoids, and pepper.

2. The method of claim 1, wherein the pepper includes at least one of black or white pepper.

3. The method of claim 2, wherein the pepper includes an extract of pepper.

4. The method of claim 2, wherein the pepper is finely powdered and suspended in an oil-water emulsion to form a colloidal suspension.

5. The method of claim 2, wherein the pepper includes an essential oil of Piper nigrum extracted by steam distillation or super critical CO2 extraction protocols.

6. The method of claim 2, comprising:
mixing the blended oral composition into a vitamin and mineral enriched flavored oral preparation beverage.

7. The method of claim 6, comprising:
combining the blended oral composition into at least one of gummies, capsules, candies, or other edible products.

8. The method of claim 1, wherein the cannabis oil is a total cannabis oil containing various Cannabinoids.

9. The method of claim 8, wherein the Cannabinoids include at least one of tetrahydrocannabinol (THC) or cannabidiol (CBD).

10. The method of claim 8, wherein the Cannabinoids include tetrahydrocannabinol (THC) with at least one of Cannabinol (CBN), Cannabigerol (CBG), Cannabichromenic acid (CBCa), Tetrahydrocannabivarin (THCV), cannabis terpenes, or Cannabidiol (CBD) oil.

11. The method of claim 8, wherein the Cannabinoids include Cannabidiol (CBD) with no trace of tetra hydro cannabinol (THC).

12. The method of claim 8, wherein the Cannabinoids include oil containing a ratio of Cannabidiol (CBD) to tetrahydrocannabinol (THC) with other psychoactive Cannabinoids.

13. The method of claim 8, wherein the Cannabinoids include oil containing a ratio of Cannabidiol (CBD) to tetrahydrocannabinol (THC) with other non- psychoactive Cannabinoids.

14. The method of claim 1, including deriving the turmeric curcuminoids from rhizomes of Turmeric (Curcuma longa).

15. The method of claim 1, including combining vitamin and mineral contents meeting RDA requirements into the blended oral composition.

16. A blended oral composition consisting essentially of:
cannabis oil;
turmeric curcuminoids;
flavonoids; and
pepper.

17. The composition of claim 16, wherein the pepper includes one of black or white pepper.

18. The composition of claim 17, wherein the cannabis oil includes tetrahydrocannabinol (THC) with at least one of Cannabinol (CBN), Cannabigerol (CBG), Cannabichromenic acid (CBCa), Tetrahydrocannabivarin (THCV), cannabis terpenes, or Cannabidiol (CBD) oil.

19. The composition of claim 17, wherein the cannabis oil includes Cannabidiol (CBD) with no trace of tetrahydrocannabinol (THC).

20. The composition of claim 17, wherein the cannabis oil includes a ratio of Cannabidiol (CBD) to tetrahydrocannabinol (THC) with other Cannabinoids.
